(19) United States
(12) Patent Application Publication
(10) Pub. No.: US 2005/0259079 A1
(43) Pub. Date: Nov. 24, 2005

(54) Computer keyboard

(76) Inventors: Hwan-Chul Kim, Daejo (KR); Kyeong-Jae Cheon, Daejon (KR); Yong-Hoon Cho, Daejon (KR)

Correspondence Address: GREENBLUM & BERNSTEIN, P.L.C., 1950 ROLAND CLARKE PLACE, RESTON, VA, 20191, US

(21) Appl. No.: 10/416,508

(22) PCT Filed: Nov. 20, 2001
(86) PCT No.: PCT/KR01/01986

§ 371 Date: May 21, 2003

(30) Foreign Application Priority Data
Nov. 22, 2000 (KR) 200069558

(51) Int. Cl. G09G 5/00

(52) U.S. Cl. 345/168

(57) ABSTRACT

A computer keyboard is provided which is constructed in such a manner that an auxiliary key group of the keyboard is moved to the left of a text creation key group, the phase of the keys of each key group belonging to the auxiliary key group being mirrorlike-symmetrical with respect to the right-handed standard phase, thereby mitigating confusion in user feels.

### BACKGROUND OF THE INVENTION

1. Field of the Invention

The present invention generally relates to a computer keyboard and, more particularly, to a computer keyboard constructed in a manner that its auxiliary keys are arranged on the left side so as to correspond to both hands of the human body, thereby mitigating confusion its user feels.

2. Description of the Related Art

A keyboard, a typical input device of a computer, is constructed in such a manner that alphabet keys, numeral keys, special character keys, special command keys and the like are arranged, and performs a variety of operations by pushing one or several of these keys Types of computers compatible with IBM-PC employed 84 keys at first, but computers developed after AT use extended keys such as 101 keys, 103 keys, 106 keys and the like. In keyboard used in countries other than English-speaking countries, their native characters are allocated to alphabet keys

FIG. 1 illustrates the structure of a conventional keyboard. As shown in FIG. 1, the conventional computer keyboard 1 is constructed in such a manner that a key group 2 (referred to as “text creation key group” hereinafter) constituted of alphabet characters, numerals and basic arithmetical operation signs such as “+”, “−” and the like, various special characters, “Backspace” and “Enter” is arranged on the left side thereof.

A key group 3 used for inputting designated functions (referred to as “function key group hereinafter) is generally arranged above the text creation key group 2, and a key group 5 configured of direction indicating arrows (referred to as “movement key group” hereinafter) is located at the bottom of the right side of the text creation key group 2. Further, a key group 7 constructed of signs used for text edition, such as “Insert”, “Home”, “Page up”, “Delete”, “End” and “Page down” (referred to as “text edition key group” hereinafter) is arranged above the movement key group 5, and, a key group 4 including “Print Scrn SysRq”, “Scroll Lock” and “Pause” keys (referred to as “special control key group” hereinafter) is located above the text edition key group 7.

A key group 6 (referred to as “edition/operation key group” hereinafter) constructed in a manner that numerals, basic four arithmetical operations, direction indicating arrows, the text edition signs included in the text edition key group 7, and “Enter” sign are appropriately assigned to keys is arranged on the right side of the keyboard 1. Minimum keys that must be included in the key groups and position correlation of the keys are standardized internally. In FIG. 1, reference numeral 2a indicates “Enter” key of the text creation key group 2 that is used more frequently than other keys, and 6a represents “Enter” key that belongs to the edition/operation key group 6.

Position correlation between the key groups is defined as “phase” and, especially, position correlation between the key groups of the convention keyboard is defined as “standard phase for the right hand” in the specification and the appended claims. Further, in order to distinctly compare the operation and effect of the keyboard according to the present invention with those of the conventional keyboard, a term “auxiliary key group” is used that includes the movement key group, edition key group, special control key group and edition/operation key group.

Meanwhile, there are being invented various kinds of keyboards, for example, a keyboard having smooth ‘V’ shape in consideration of human body engineering and a keyboard whose shape and key arrangement are variously changed to allow its user to be able to typewrite in a more convenient posture. However, a user who operates a keyboard mouse with his right hand cannot conveniently uses these kinds of keyboards together with the mouse. In addition, the user who is accustomed to the conventional key arrangement feels uncomfortable in using the keyboards having varied arrangements.

Although a computer user operates the mouse more frequently because various application programs, network programs and Internet web pages as well as operating system programs have been recently constructed based on the graphic user interface, keyboard operation is still required for text creation/edition, game, arithmetic operation, inputting of a web site address in utilization of the Internet, signing in various web sites an so forth.

FIG. 2 illustrates phase correlation among the monitor, keyboard and mouse of a computer system employing the conventional keyboard from the standpoint of a user who operates the mouse with his right hand. As shown in FIG. 2, in case where the monitor 30 is placed right in front of the user and the mouse 40 is located on the right side of the keyboard 1, the auxiliary key group 8 is positioned approximately in front of the user and the text creation key group 2 and mouse 40 are placed on the left and right sides of the user respectively. This makes the user uncomfortable and deteriorates operation efficiency of the keyboard 1 or mouse 40.

FIG. 3 is a diagram for explaining problems generated when the computer system arranged as shown in FIG. 2 uses the keyboard 1. As shown in FIG. 3, when a user operates the text creation key group 2 using the computer system employing the conventional keyboard 1, the user cannot balance his body because his both hands are put on the left side. This affects the backbone, shoulder and wrist of the user.

FIG. 4 is a diagram for explaining problems generated when the text creation key group and the mouse are alternately used in the computer system arranged as shown in FIG. 2. As shown in FIG. 4, in case where the user alternately uses the text creation key group 2 and the mouse 40 of the computer system employing the conventional keyboard 1, the space between the mouse 40 and the text creation key group 2 is wide so that the movement distance of the user's right hand becomes longer. This causes a pain in the user's right shoulder.

FIG. 5 is a diagram for explaining problems generated when the auxiliary key group and the mouse are alternately used in the computer system arranged as shown in FIG. 2. As shown in FIG. 5, when the user alternately operates the auxiliary key group 8 and the mouse 40 of the computer system employing the conventional keyboard 1, the user cannot balance his body because his both hands are put on the right side. This affects the backbone, shoulder and wrist of the user. These harmful effects given to the user's body deteriorate operation efficiency of the keyboard and mouse.

The inventor proposed a computer keyboard (Korean Patent No. 201945, registered on 25^{th} of August, 2000) that is constructed in such a manner that the auxiliary key group is moved in parallel to be arranged on the left side of the text creation key group and the right-handed standard phase is employed as the phase of the keys belonging to the auxiliary key group. However, this invention does not reflect the fact on the keyboard that the fingers of both hands of the human are symmetrical and they take reflection reaction symmetrically. Thus, a user whose is accustomed to the right-handed standard phase feels uncomfortable when he operates the keys of the auxiliary key group with his left hand.

### SUMMARY OF THE INVENTION

It is, therefore, an object of the present invention to provide a computer keyboard constructed in such a manner that the auxiliary key group of the keyboard is moved to the left of the text creation key group, the phase of the keys of each key group belonging to the auxiliary key group being mirrorlike-symmetrical with respect to the right-handed standard phase, thereby mitigating confusion its user feels.

To accomplish the object of the present invention, there is provided a computer keyboard comprising an auxiliary key group including a special control key group, a text edition key group, a movement key group and an edition/operation key group, and a text creation key group, wherein the auxiliary key group is located on the left of the text creation key group, the movement key group of the auxiliary key group being placed at the bottom of the right side, the text edition key group being located above the movement key group, the special control key group being arranged above the text edition key group, the edition/operation key group being placed on the left of the movement key group, and the phase of the keys of the edition/operation key group is mirrorlike-symmetrical with respect to the right-handed standard phase.

### BRIEF DESCRIPTION OF THE DRAWINGS

Further objects and advantages of the invention can be more fully understood from the following detailed description taken in conjunction with the accompanying drawings, in which:

FIG. 1 illustrates the structure of a conventional computer keyboard;

FIG. 2 illustrates phase relation among the monitor, keyboard and mouse of a computer system employing the conventional keyboard from the standpoint of a user who operates the mouse with his right hand;

FIG. 3 is a diagram for explaining problems generated when a text creation key group is used the computer system arranged as shown in FIG. 2;

FIG. 4 is a diagram for explaining problems generated when a text creation key group and a mouse are alternately used in the computer system arranged as shown in FIG. 2;

FIG. 5 is a diagram for explaining problems generated when an auxiliary key groups and a mouse are alternately used in the computer system arranged as shown in FIG. 2;

FIG. 6 illustrates the structure of a computer keyboard according to the present invention;

FIG. 7 illustrates phase relation among the monitor, keyboard and mouse of a computer system employing a keyboard according to the invention from the standpoint of a user who operates the mouse with his right hand;

FIG. 8 is a diagram for explaining advantages obtained when a text creation key group is used the computer system arranged as shown ia FIG. 7;

FIG. 9 is a diagram for explaining advantages obtained when a text creation key group and a mouse are alternately used in the computer system arranged as shown in FIG. 7; and

FIG. 10 is a diagram for explaining advantages attained when an auxiliary key groups and a mouse are alternately used in the computer system arranged as shown in FIG. 7.

### DETAILED DESCRIPTION OF THE PREFERRED EMBODIMENT

The present invention will now be described in connection with preferred embodiments with reference to the accompanying drawings.

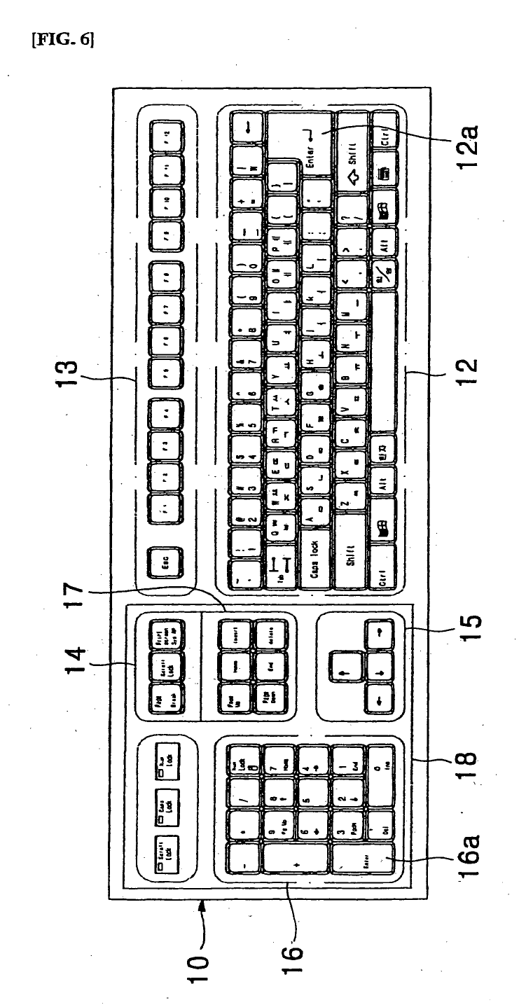

FIG. 6 illustrates the structure of a computer keyboard according to the present invention. Referring to FIG. 6, the keys of the keyboard are arranged in a manner that the phase of key groups belonging to the auxiliary key group is symmetrical with respect to the right-handed standard phase. Specifically, the computer keyboard according to the present invention is constructed in such a manner that a text creation key group 12 constituted of alphabet characters, numerals and basic arithmetical operation signs such as “+”, “−” and the like, various special characters, “Backspace” and “Enter'” is arranged on the right side of the keyboard. The phase of the keys belonging to the text creation key group 12 is identical to the right-handed standard phase and, thus, “Enter” key 12a is placed on the right end of the keyboard.

A function key group 13 used for inputting designated functions is arranged above the text creation key group 12, and a movement key group 15 configured of direction indicating arrows is located at the bottom of the left of the text creation key group 12. Further, a text edition key group 17 constructed of signs used for text edition, such as “Insert”, “Home”, “Page up”, “Delete”, “End” and “Page down” is arranged above the movement key group 15, and a special control key group 14 including “Print Scrn SysRq”, “Scroll Lock” and “Pause” keys is located above the text edition key group 17.

An edition/operation key group 16 constructed in a manner that numerals, basic four arithmetical operations, direction indicating arrows, the text edition signs included in the text edition key group 17, and “Enter” are appropriately assigned to keys is arranged on the left end of the keyboard.

In the aforementioned structure, the keys of the edition/operation group 16 that are used more frequently than other key groups in the auxiliary key group 18 are arranged such that their phase is mirrorlike-symmetrical with respect to the right-handed standard phase. Specifically, “1(End)”, “2(↓)” and “3(Del)” keys, which were arranged from the left to the right and respectively pushed by the index finger, middle finger and ring finger of its user's right hand in the conventional keyboard 1, are arranged from the right to the left and respectively pushed by the index finger, middle finger and ring finger of its user's left hand in the present invention. This mitigates confusion the user feels when he uses the keyboard whose key arrangement has been varied.

The phase of the keys of the other key groups belonging to the auxiliary key group 18 is mirrorlike-symmetrical with respect to the right-handed standard phase, to thereby relieve the user's confusion.

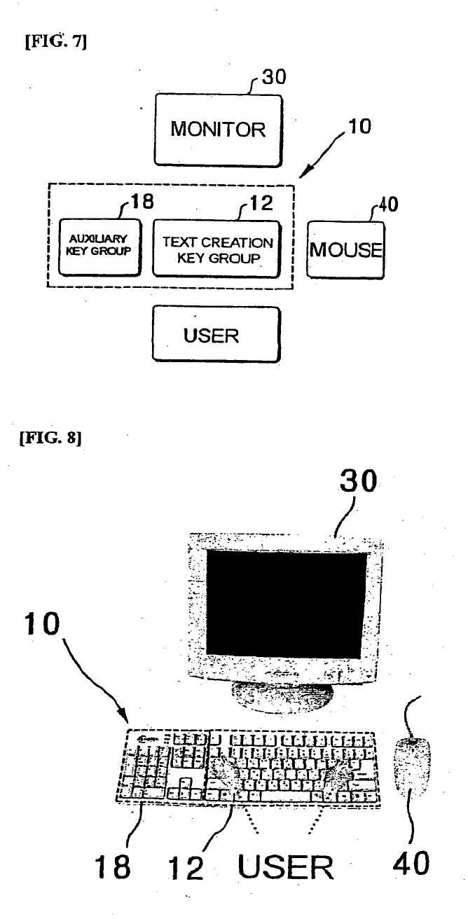

FIG. 7 illustrates phase relation among the monitor, keyboard and mouse of a computer system employing the keyboard according to the invention from the standpoint of a user who operates the mouse with his right hand. As shown in FIG. 7, in case where the monitor 30 is placed right in front of the user and the mouse 40 is located on the right side of the keyboard 10, the text creation key group 12 is positioned approximately in front of the user and the auxiliary key group 18 and the mouse 40 are placed on the left and right sides of the user respectively. This allows the user to be able to operate the keyboard 10 or the mouse 40 in a balanced posture in various situations which will be explained below. Accordingly, the user feels comfortable when using the keyboard, and operation efficiency of the keyboard 10 and mouse 40 is improved.

FIG. 8 is a diagram for explaining advantages obtained when the text creation key group is used in the computer system arranged as shown in FIG. 7. As shown in FIG. 8, when a user operates the text creation key group 12 using the computer system employing the keyboard 10 of the invention, the user can operate the keyboard 10 in a balanced posture because his both hands are respectively put on the left and right sides of the keyboard with his body in the center. This drastically mitigates strain put on the backbone, shoulder and wrist of the user, compared with the case of FIG. 3.

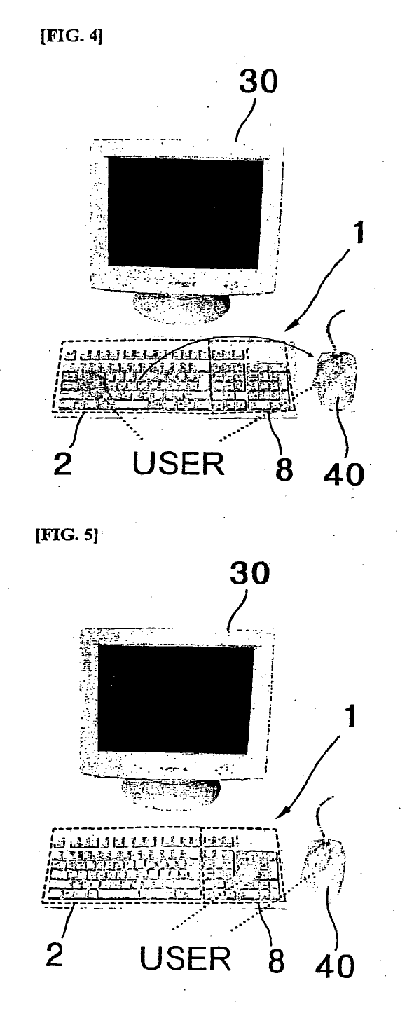

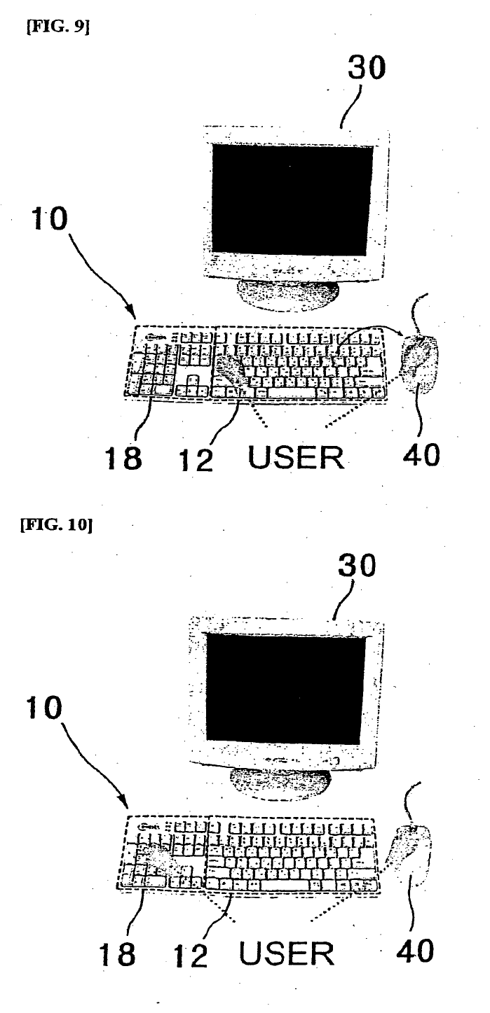

FIG. 9 is a diagram for explaining advantages attained when the text creation key group and the mouse are alternately used in the computer system arranged as shown in FIG. 7. As shown in FIG. 9, in case where the user alternately uses the text creation key group 12 and the mouse 40 of the computer system employing the keyboard 10 of the invention, the space between the mouse 40 and the text creation key group 12 becomes narrower, compared to the case shown in FIG. 4, so that the movement distance of the user's right hand becomes shorter as indicated by the arrow. This remarkably relieves strain put on the user's right shoulder and improves key operation efficiency.

FIG. 10 is a diagram for explaining advantages obtained when the auxiliary key group and the mouse are alternately used in the computer system arranged as shown in FIG. 7. As shown in FIG. 10, when the user alternately operates the auxiliary key group 18 and the mouse 40 of the computer system employing the keyboard 10 of the invention, the user can operate the keyboard 10 and the mouse in a balanced posture because his both hands are respectively put on the left and right sides of the keyboard with his body in the center. This considerably mitigates strain put on the backbone, shoulder and wrist of the user, compared to the case of FIG. 5.

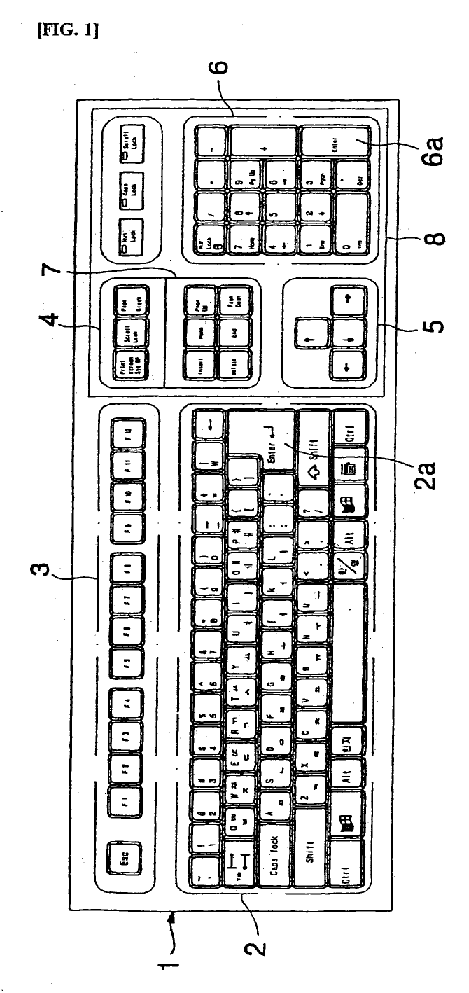

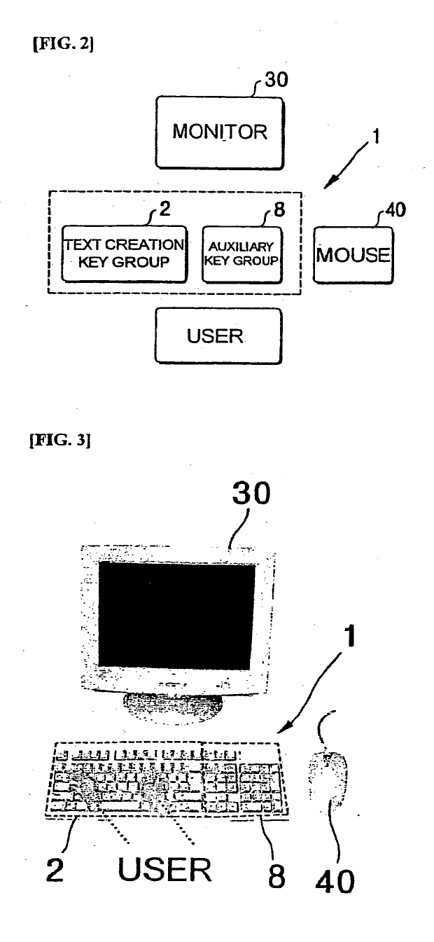

In the Internet environment using the mouse 40 and “Enter” key frequently, the user can operate the “Enter” key 16a belonging to the edition/operation key group 16 of the auxiliary key group 18 with his little finger while grasping the mouse 40 with his right hand even without confirming the key 16a with his eyes because the “Enter” key 16a is located at the bottom of the left side of the keyboard 10. This solves the problem of the conventional keyboard 1 shown in FIG. 1 that the user operates the mouse 40 and “Enter” key 6a of the edition/operation key group 6 alternately with his right hand. The keyboard according to the present invention also solves the problems of the conventional keyboard that the user operates “Enter” key 2a of the text edition key group 2 with his left hand while grasping the mouse 40 with his right hand in an uncomfortable posture and that the user should confirm the key 2a with his eyes when he push it because other keys are located on the left and right sides of the key 2a.

Meanwhile, in case of a bank where the keys of the edition/operation key group 16 are frequently used, the keys, which were operated with the fingers of the user's right hand in the conventional case, are operated with the same fingers of the left hand so that user's confusion can be considerably mitigated.

Moreover, since there is no key placed on the right side of “Enter” key 12a of the text creation key group 12 in the keyboard 10 of the present invention, a user, who is accustomed to alternate operation of the mouse 40 and “Enter” key of the text creation key group 12 with his right hand, does not feel uncomfortable when he uses the keyboard of the invention.

Although specific embodiments including the preferred embodiment have been illustrated and described, it will be obvious to those skilled in the art that various modifications may be made without departing from the spirit and scope of the present invention, which is intended to be limited solely by the appended claims. For example, the present invention is not limited to the keyboard having the shape shown in FIG. 6 but it can be applied to a keyboard having the shape of reverse V that is fabricated in consideration of human body engineering and a keyboard whose left and right parts are separated from each other. Furthermore, the present invention can be applied to a keyboard that additionally has various abbreviated keys, for instance, abbreviated key for Internet access, volume control key, sound erasure key or the like.

According to the computer keyboard of the invention, which is adapted for a user who operates a mouse with high right hand, as described above, the auxiliary key group of the keyboard is moved to the left of the text creation key group, the phase of the keys of each key group belonging to the auxiliary key group being mirrorlike-symmetrical with respect to the right-handed standard phase. Therefore, confusion that the user who operates the mouse with high right hand feels is minimized, strain put oil the user's body is mitigated, and operation efficiency of the keyboard and mouse is improved.

1. (canceled)

2. (canceled)

3. (canceled)

4. A computer keyboard comprising an auxiliary key group including a special control key group, a text edition key group, a movement key group and an edition/operation key group, and a text creation key group,
wherein the auxiliary key group is located on the left of the text creation key group, the movement key group of the auxiliary key group being placed at the bottom of the right side, the text edition key group being located above the movement key group, the special control key group being arranged above the text edition key group, the edition/operation key group being placed on the left of the movement key group, and the phase of the keys of the edition/operation key group, the movement key group, the text edition key group and the special control key group are mirrorlike-symmetrical with respect to the right-handed standard phase.
